(19) United States
(12) Patent Application Publication
(10) Pub. No.: US 2003/0093797 A1
(43) Pub. Date: May 15, 2003

(54) Transmission system for transmitting video streams relating to an event to spectators physically present at said event

(76) Inventor: Paul Bazzaz, Paris (FR)

Correspondence Address: U.S. Philips Corporation, 580 White Plains Road, Tarrytown, NY, 10591, US

(21) Appl. No.: 10/291,011

(22) Filed: Nov. 8, 2002

(30) Foreign Application Priority Data
Nov. 13, 2001 (FR) 0114666

(51) Int. Cl. H04N 7/18

(52) U.S. Cl. 725/74; 348/157

(57) ABSTRACT

A transmission system according to the invention comprises a wireless access point (7) having a coverage area covering at least part of the site (1) at which an event is taking place, intended to receive video streams relating to said event and to relay them to spectators (S1, S2, S3) who are physically present at said event and equipped with a portable display device.

The invention makes it possible to combine the advantages which are conventionally enjoyed separately, on the one hand, by the spectators who are on site (atmosphere etc) and, on the other, the viewers (access to additional information, ease of display etc).

The invention relates to a transmission system including cameras for acquiring images relating to an event which is taking place at a certain site, at least one processing center for producing video streams from said images, and means of transmitting one or more of said video streams.

The invention also relates to a wireless access point intended to be used in such a transmission system.

The invention also relates to a method of distributing video streams relating to an event taking place at a certain site, including a step of acquiring images with cameras located at said site, a step of producing video streams from said images, and a step of transmitting one or more of said video streams.

The invention applies in particular to the field of leisure, education and entertainment services.

International patent application WO 98/41020 published on Sep. 17, 1998 describes a system for interactive transmission by cable, satellite, cabled link or radio broadcast, enabling viewers who are not physically present at an event (for example a sporting event) to receive several video streams corresponding to various shots of the event, as well as specific services such as slow motion, action replays, statistics and interviews, using a television receiver or a personal computer equipped with a television card. Each viewer can at any time choose the video stream which he wishes to display from among a certain variety of video streams available. The possibilities thus offered to viewers are very attractive. The aim of the invention is in particular to propose a transmission system which offers this type of possibility to other types of users.

A transmission system according to the invention and as described in the introductory paragraph is characterized in that it includes at least one wireless access point having a coverage area covering at least some of said site, intended to receive at least one of said video streams and to relay it by radio so that it can be received by one or more spectators equipped with a portable display device situated in said coverage area.

Likewise, a method according to the invention of distributing video streams relating to an event taking place at a certain site is characterized in that it includes a step of transmitting at least one of said video streams to a wireless access point having a coverage area covering at least part of said site, and a step of relaying said video stream by radio from said wireless access point, so that it can be received by one or more spectators equipped with a portable display device situated in said coverage area.

Thus the invention enables a spectator who is physically present at the event to gain access to the same services as those to which the viewers who have remained at home have access. With the invention, it is possible to add together advantages which conventionally separately benefit firstly the spectators who are at the site and secondly the viewers who remain at home. The invention for example enables people keen on a sport to be immersed in the atmosphere of a match while having available additional information such as scores, statistics, slow motion, replay of important action, interviews with players etc.

The invention also enables a spectator who is not well placed in the stadium for following an action to follow this same action from his portable device.

The invention also enables a spectator who has chosen to physically attend a certain match to display video streams relating to other matches taking place simultaneously, for example during interruption in play, in order to keep himself informed about developments at these other matches.

Moreover, the use of a personal portable device makes it possible to obtain great ease in use. This type of display device offers in fact good display quality and the user is free to position it at his convenience in order to optimize his ease of use.

In an advantageous embodiment of the invention, said portable display device has a man-machine interface for selecting the video stream to be displayed from among several video streams broadcast by the same wireless access point. A service of the “broadcast” type or a service of the “multicast” type is then spoken of when the streams broadcast are accessible to a group of several users.

In another advantageous embodiment of the invention, the transmission system includes a database in which one or more video streams are prerecorded, and said portable display device has a man-machine interface for selecting a video stream prerecorded in said database in order to display it. A service of the “unicast” type is then spoken of.

These two embodiments make it possible to personalize the service offered to spectators since each spectator can thus choose, at any time, the stream which he wishes to access.

When the spectator has access to prerecorded video streams (the so-called “unicast” service), the man-machine interface is advantageously designed to enable the spectator to navigate in the prerecorded video stream which he has selected, for example to make pauses, fast forward, rewind, stops etc.

Advantageously a distribution method according to the invention includes a billing step. The billing depends for example on the service, “unicast” or “broadcast”, to which the spectator gains access, the service of the “unicast” type being in principle more expensive than the service of the “broadcast” type.

For example, the billing step involves an electronic transaction between a transaction server and said portable display device.

In an advantageous embodiment, the distribution method according to the invention includes a renting step of offering said portable display device for rent to spectators present at an event. The rental price comprises for example the price for access to the so-called “broadcast” service and/or to the so-called “unicast” service at the choice of the spectator.

Advantageously, the distribution method according to the invention leaves the spectator the possibility of using a personal portable display device.

The invention is not limited to sporting events. It is applicable to any type of event, in particular to shows, educational, political and trade events etc.

The invention will be further described with reference to examples of embodiment shown in the drawings to which, however, the invention is not restricted.

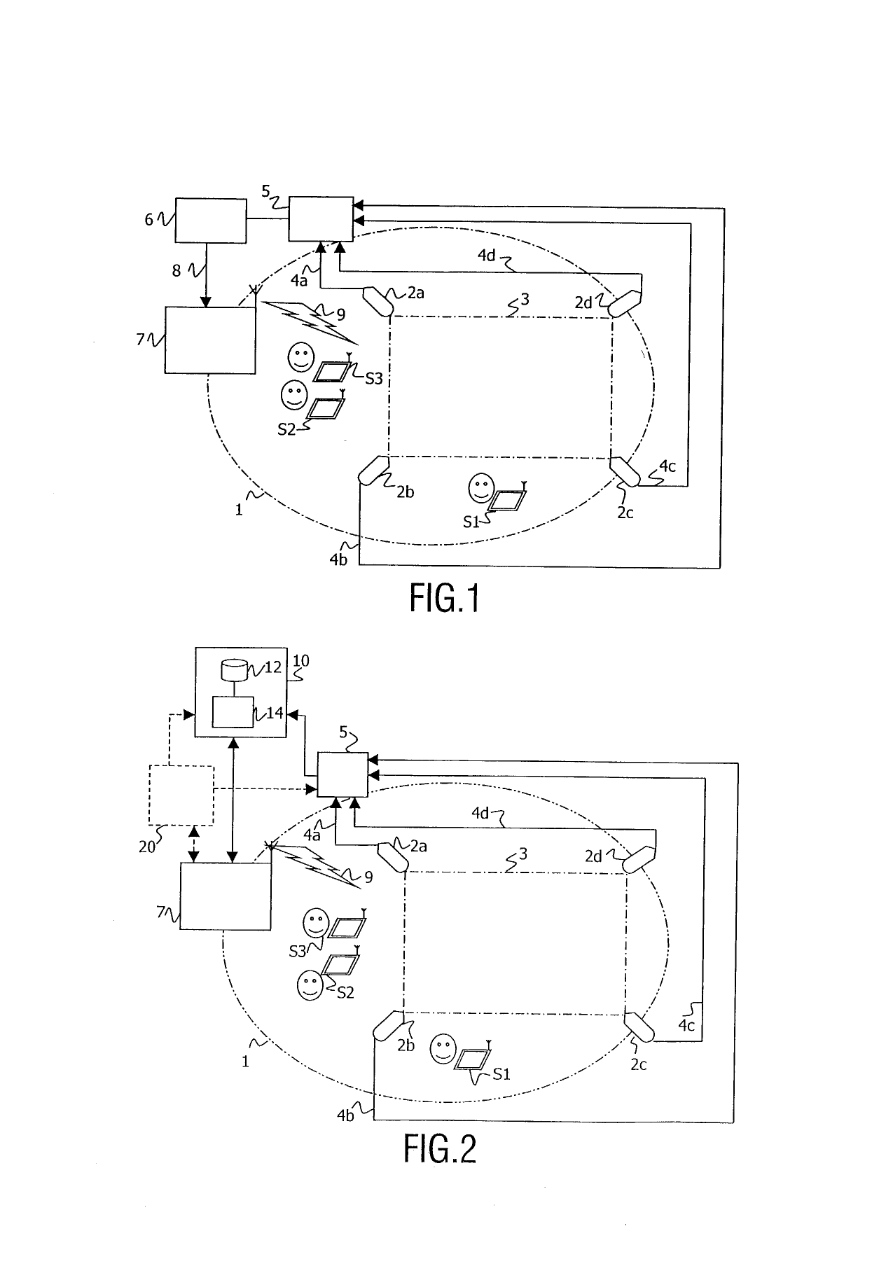

FIG. 1 depicts an example of a transmission system according to the invention, for implementing a service of the “broadcast” type,

FIG. 2 depicts an example of a transmission system according to the invention, for implementing a service of the “unicast” type.

FIG. 1 depicts a site 1 at which an event is taking place. Cameras 2a to 2d are placed so as to capture images relating to said event from different camera angles. In FIG. 1, the cameras 2a to 2d are placed at each of the four comers of a rectangle 3 representing a sports field. The image is captured by the four cameras 2a to 2d and transmitted to a processing center 5 via links 4a to 4d. The processing center 5 effects a video encoding of the captured images and produces compressed video streams, for example video streams according to the MPEG-2 format. For images according to the CCIR format with 25 images per second, the transmission rate between each camera 2a to 2d and the video encoder 5 is around 150 Mbps.

The links 4a to 4d consist for example of high-rate cables. The video streams produced by the processing center 5 are transmitted by a transmission module 6 to a wireless access point 7 via a link 8.

The compression carried out by the processing center 5 reduces the transmission rate necessary for the transmission of the video streams to the wireless access point 7.

At the present time, the wireless access points available on the market are provided with an Ethernet input and a wireless output. When the processing center 5 and the wireless access point 7 are installed close to one another (for example at the site 1), the link 8 is therefore advantageously an Ethernet link. Typically an Ethernet link makes it possible to connect two items of equipment around 200 to 300 m apart, with a transmission rate of around 100 Mbps. When the processing center 5 and the wireless access point 7 are further apart (that is to say when the processing center is not installed at the site 1), an optical link or a link of the ISDN type is for example used, with a converter to Ethernet at the input to the wireless access point.

The wireless access point 7 broadcasts by radio 9 the video streams which it receives from the transmission module 6. For example, the radio link 9 is an IEEE 802.11 link offering a maximum transmission rate of 11 Mbps. Any other high-rate local wireless transmission means can be used (for example, it can be envisaged using future developments to the family of 802 wireless transmission standards, or the Hiperlan II standard).

The video streams are transported using conventional transport protocols, for example the RTP on UDP on IP protocols.

In certain embodiments, in particular when the size of the service to be rendered so requires, that is to say when the number of areas to be served and/or the number of video streams to be transmitted for each area are high, the transmission system according to the invention includes several wireless access points 7. In this case, the transmission module 6 includes one or more items of transmission equipment of the repeater/bridge/exchanger/router type for transporting the streams from the processing center 5 to the wireless access points 7. The interfaces between these items of transmission equipment are for example compatible Ethernet interfaces, supporting a transmission rate which may vary from a minimum of 10 Mbps up to more than 1 Gbps. The links between these items of transmission equipment are for example optical or metallic.

In FIG. 1, three spectators are each provided with a portable display device, referred to as S1, S2 and S3 respectively, intended to receive video streams broadcast by the wireless access point 7. In practice, these display devices have a man-machine interface, for example a graphical interface, making it possible to announce to each spectator the video streams available, so that the user can at any time select the video stream which he wishes to display. The graphical interface includes for example an icon for each video stream available. The spectator can select the icon which corresponds to the video stream which interests him with a selection tool, for example a pen if the display device is provided with a touch screen, or one or more cursor movement keys otherwise.

In addition to the announcement of the video streams available, the portable display devices receive information, not visible to the user, which describes the characteristics of the video streams available. This information comprises in particular connection identifiers (for example an identifier for the radio channel and an identifier for the RTP/UDP/IP communication port to be used for said connection), and identifiers for the format of the video stream (for example identifiers indicating the coding standard, the image format and the transmission rate used etc.)

Thus, when the spectator selects an icon, the device automatically switches to the RTP/UDP/IP access port on which said video stream is being transmitted.

FIG. 2 depicts an example of a transmission system according to the invention, offering to the spectator a service of the “unicast” type. According to FIG. 2, the processing center 5 is connected to a server 10 containing a database 12 and a transmission module 14 which is itself connected to the wireless access point 7. Video streams which have previously been encoded are stored in the database 12. In the same way as before, the transmission module 14 can include one or more items of transmission equipment of the repeater/bridge/exchanger/router type, for transmitting the video streams from the database 12 to several wireless access points 7.

In practice, the streams prerecorded at the server are shown in the form of icons on the screen of the portable display device of the spectator, so that the latter can at any time select the prerecorded stream that interests him. When the spectator selects a stream, a request is sent from the portable display device to the server 10. The server 10 responds to this request by indicating the technical characteristics to be used for receiving the stream (radio frequency portion and possibly time portion dedicated to the spectator, RTP/UDP/IP access port corresponding to the prerecorded stream selected). To do this, it is possible to use an owner protocol or known protocols such as SAP (Session Announcement Protocol) or SDP (Session Description Protocol). The SAP protocol is defined in RFC 2974 from the IETF published in October 2000. The SDP protocol is defined in a draft from the IFTP dated Jul. 13, 2001.

Advantageously, the RTSP protocol (Real Time Streaming Protocol) defined in RFC 2326 of April 1998 is used to enable the spectator to navigate in the prerecorded stream which he has selected, for example to make pauses, stops, fast forward, rewind etc. The navigation commands placed by the spectator are sent to the server 10 and executed by the server.

In an advantageous embodiment, the means described with regard to FIGS. 1 and 2 are combined in order to offer to the spectator the so-called “broadcast” services and the so-called “unicast” services.

Optionally, when the format of the images captured by the cameras does not correspond to the conventional display format on the portable display devices, it is necessary to provide a video preprocessing before the encoding described above, in order to convert the format of the images acquired to the conventional display format on the screen of said portable device.

Advantageously the video distribution method according to the invention includes a step of offering portable devices for rent, for example on the site 1. The cost of the rent advantageously includes the price of access to the “broadcast” and/or “unicast” service.

In another embodiment, an electronic billing step is implemented between the portable display device and a transaction server 20 (shown in dotted lines in FIG. 2) for billing the “unicast” service. Access to the service is then possible only when the transaction has been successful.

1. A transmission system comprising cameras (2a, 2b, 2c) for acquiring images relating to an event which is taking place at a certain site (1), at least one processing center (5) for producing video streams from said images, and means (6) of transmitting one or more of said video streams, characterized in that it comprises at least one wireless access point (7) having a coverage area covering at least part of said site, intended to receive at least one of said video streams and to relay it by radio (9) so that it can be received by one or more spectators (S1, S2, S3) equipped with a portable display device situated in said coverage area.

2. A transmission system as claimed in claim 1, characterized in that said portable display device has a man-machine interface for selecting the video stream to be displayed from among several video streams broadcast by said wireless access point.

3. A transmission system as claimed in claim 1, characterized in that it includes a database (12) in which one or more video streams are prerecorded, and in that said portable display device has a man-machine interface for selecting a video stream prerecorded in said database in order to display it.

4. A transmission system as claimed in claim 3, characterized in that said man-machine interface makes it possible to navigate in the prerecorded video stream which has been selected.

5. A wireless access point (7), characterized in that it has a coverage area covering at least part of a site (1) at which one or more events are intended to take place, and in that it is intended to receive one or more video streams produced from images relating to an event taking place at said site and captured by one or more cameras (2a, 2b, 2c) placed at said site (1), in order to relay said video stream or streams by radio (9) to one or more spectators (S1, S2, S3) attending said event and equipped with a portable display device.

6. A method of distributing video streams relating to an event taking place at a certain site (1), including a step of acquiring images with cameras (2a, 2b, 2c) located at said site, a step of producing video streams from said images, and a step of transmitting one or more of said video streams, characterized in that it includes a step of transmitting at least one of said video streams to a wireless access point (7) having a coverage area covering at least part of said site, and a step of relaying said video stream by radio (9) from said wireless access point, so that it can be received by one or more spectators (S1, S2, S3) equipped with a portable display device situated in said coverage area.

7. A method of distributing video streams as claimed in claim 6, characterized in that it includes a step of prerecording in a database (12) one or more video streams relating to said event, and in that a step of selecting a video stream prerecorded in said database can be implemented by a spectator (S1, S2, S3) using said portable device, in order to display the prerecorded video stream selected.

8. A video stream distribution method as claimed in one of claims 6 or 7, characterized in that it includes a billing step.

9. A video stream distribution method as claimed in claim 8, characterized in that said billing step includes an electronic transaction step between a transaction server (20) and said portable display device (S1, S2, S3).

10. A video stream distribution method as claimed in one of claims 6 or 7, characterized in that it includes a renting step of offering said portable display device for rent to the spectators present at said event.
